(19) United States
(12) Patent Application Publication
(10) Pub. No.: US 2022/0274194 A1
(43) Pub. Date: Sep. 1, 2022

(54) Method for Producing Tooth Flank Modifications on Toothing of Workpieces and Tools for Performing Said Method

(71) Applicant: Rheinisch-Westfälische Technische Hochschule (RWTH) Aachen, Aachen (DE)

(72) Inventors: Christoph Löpenhaus, Aachen (DE); Christian Brecher, Aachen (DE)

(21) Appl. No.: 17/623,901

(22) PCT Filed: Jun. 30, 2020
(86) PCT No.: PCT/EP2020/000123

§ 371 Date: Dec. 30, 2021

(30) Foreign Application Priority Data
Jul. 2, 2019 (DE) 10 2019 004 667.0

(51) Int. Cl. B23F 19/00; B23F 21/10; B23F 21/02

(52) U.S. Cl. CPC B23F 19/002; B23F 21/10; B23F 21/026

(57) ABSTRACT

The invention relates to a method for producing tooth flank modifications on toothing of workpieces, in which the workpiece and a tool are moved relative to one another and, as a result, material is removed from the tooth flank (3) of the workpiece. Different tooth flank modifications are generated on teeth (1) of the workpiece by means of a continuously rolling manufacturing process, by the tool comprising individually different tool profile geometries which generate the different tooth flank modifications on the teeth (1) of the workpiece. The tool can be a dresser with variable profile in order to provide, with dressable tools, individually different tool profile geometries.

The invention concerns a method for producing tooth flank modifications on toothings of workpieces according to the preamble of claim 1 as well as at least one tool for performing the method according to claim 9.

In the course of electromobility, increased importance is placed on the noise behavior of gear mechanisms. The tonal characteristic of the gear noise is perceived as particularly disturbing. Tonal noises are characterized in that the frequency spectrum comprises pronounced amplitudes of individual frequencies (tones) that lie above the amplitude level of the basic noise. In gear toothings, these are in particular, but not exclusively, the frequency of the tooth engagement and its higher harmonic that determine substantially the tonality of the gear noise. With increasing rotational speed, often the tonality increases. In order to reduce the gear noise, flank modifications that are of great importance for the running behavior are carried out at the toothings of the gear wheels. Usually, the modifications are identically provided tooth by tooth. By a variable flank modification tooth by tooth, a significant improvement of the running behavior and thus also of the noise behavior is observed because in particular the tonality, produced by an identical excitation of tooth engagement to tooth engagement, is reduced.

In order to provide such flank modifications at the teeth, usually the discontinuous profile grinding is employed. For this purpose, the position of the tool in regard to the engagement conditions at the workpiece is somewhat changed space by space. Such methods are however very complex and only little suitable for a highly productive manufacture.

For highly productive manufacturing methods, continuously rolling manufacturing methods are employed. However, only the same flank modification can always be provided by them at the teeth of the workpiece. However, the tonality and thus the noise behavior can be reduced only minimally in this way.

The invention has the object to design the method of the aforementioned kind and the tools in such a way that in an inexpensive and in a highly productive manner the noise development of a gear mechanism can be significantly reduced.

This object is solved for the method of the aforementioned kind in accordance with the invention with the characterizing features of claim 1 and for the tools in accordance with the invention with the features of claim 9.

With the method according to the invention, different tooth flank modifications at the workpiece can be produced tooth by tooth by a continuously rolling manufacturing method. For this purpose, the employed tool is provided with individually different tool profile geometries. In case of dressable tools, this geometry is introduced by a corresponding dresser with variable profile. During the rolling process, the different tooth flank modifications are produced at the teeth of the workpiece tooth by tooth with these different tool profile geometries. Depending on the configuration of the gear, the tool profile geometries at the tool are designed such that the tooth flank modifications at the workpiece formed by them lead to only a minimal noise development and in particular tonality of the gear. Due to the continuously rolling manufacturing manner the workpieces can be provided inexpensively and at high productivity.

For the continuously rolling manufacturing methods, the conventional known methods are conceivable, for example, a continuous generation grinding, continuous profile grinding, gear hobbing, gear honing, gear shaving, power skiving, gear shaping and the like. With these methods, the fine machining is possible in the soft as well as hardened workpiece material state.

Advantageously, a divider equality of number of teeth of the workpiece and number of teeth of the tool is realized.

As tools, worm-type embodied tools can be employed. They are used, for example, for continuous generation grinding, continuous profile grinding, gear hobbing and the like.

The worm-type tool can be provided with at least two threads that are differently profiled. In this manner, it is achieved that the individual tool profile geometries are periodically imprinted thread by thread on the workpiece to be machined.

The number of threads of the worm-type tool can be designed depending on the gear configuration and/or the workpiece to be machined. When the worm-type tool, for example, has three differently profiled threads, then the teeth of the workpiece are provided periodically with the corresponding tooth flank modifications. In case of three threads with different profiling, the formation of the tooth flank modifications is therefore repeated at the workpiece after three teeth, respectively.

In another advantageous embodiment, the worm-type tool is designed such that it comprises at least only one thread that along its length comprises differently profiled thread regions. These thread regions are then provided such that sequential teeth of the workpiece can be machined by them. In this case and also taking into account a targeted influence of the machining kinematics, it is not required that an integer divider is realized between the number of teeth of the workpiece and the number of threads of the tool.

The thread comprises at least two differently profiled thread regions so that at the workpiece two different tooth flank modifications can be provided. The different profiled thread regions are advantageously provided within the thread such that sequential teeth of the workpiece are provided with the respective tooth flank modification. Due to the continuously rolling manufacturing method, in the individual thread of the worm-type tool the corresponding thread regions are therefore arranged one behind the other so as to repeat at a distance. For imprinting different modifications, possibly a relative movement of the workpiece, e.g., by shifting (diagonal grinding) or a relative movement of the tool, e.g., by releasing the coupling of rolling is required.

The method is designed such that the workpiece that is installed later on in the gear can be machined directly with the tool. As tool, also a correspondingly geometrically modified dressing tool, e.g., multi-fluted profile rolls, can be employed with which the actual machining tool can be machined with respect to variable geometries. With the dressing tool, the different tooth flank modifications at the machining tool can be produced in a simple manner.

It is also possible to employ as machining tools gear wheel-type tools whose teeth are provided with different tooth geometries. They are employed, for example, for gear honing, gear shaping, power skiving, and the like. These different tooth geometries are periodically imprinted during the continuous rolling manufacturing method at the tooth flanks of the workpiece. The gear wheel-type tool has at least two different tooth geometries that advantageously are repeated irregularly about the circumference of the gear wheel-type tool.

The tool according to the invention for performing the method is characterized in that is comprises individual tool profile geometries. Depending on the number of these different tool profile geometries, at the workpiece corresponding tooth flank modifications can be provided. The tool has at least two individual tool profile geometries so that the workpiece to be machined can be provided with two different tooth flank modifications.

In an advantageous embodiment, the tool is embodied of a worm-type configuration. It can have in this context two threads that are differently profiled. With such a tool, the desired tooth flank modifications can be produced periodically at the workpiece.

In another advantageous embodiment, the tool is also of a worm-type configuration but provided with only one thread. In this case, the thread comprises along its length differently profiled thread regions. They are provided one after another at such a distance along the thread that the tooth flanks of sequential teeth of the workpiece can be modified with these thread regions.

Also, it is possible to design the tool like a gear wheel. In this case, the teeth are provided with an individual tooth geometry. This tool has then at least two individually different tooth geometries so that at the teeth of the workpiece at least two different tooth flank modifications can be provided. In this context, an integer divider ratio of the number of teeth of tool and workpiece is used.

The gear wheel-type tool can comprise an outer toothing or an inner toothing.

The tool can also be a dresser with variable profile in order to provide individually different tool profile geometries in case of dressable tools.

The subject matter of the application results not only from the subject matter of the individual claims but also from all specifications and features disclosed in the drawings and the description. They are considered important to the invention, even if they are not subject matter of the claims, inasmuch as, individually or in combination, they are novel in relation to the prior art.

Further features of the invention result from the additional claims, the description, and the drawings.

The invention will be explained in more detail with the aid of embodiments illustrated in the drawings. It is shown in

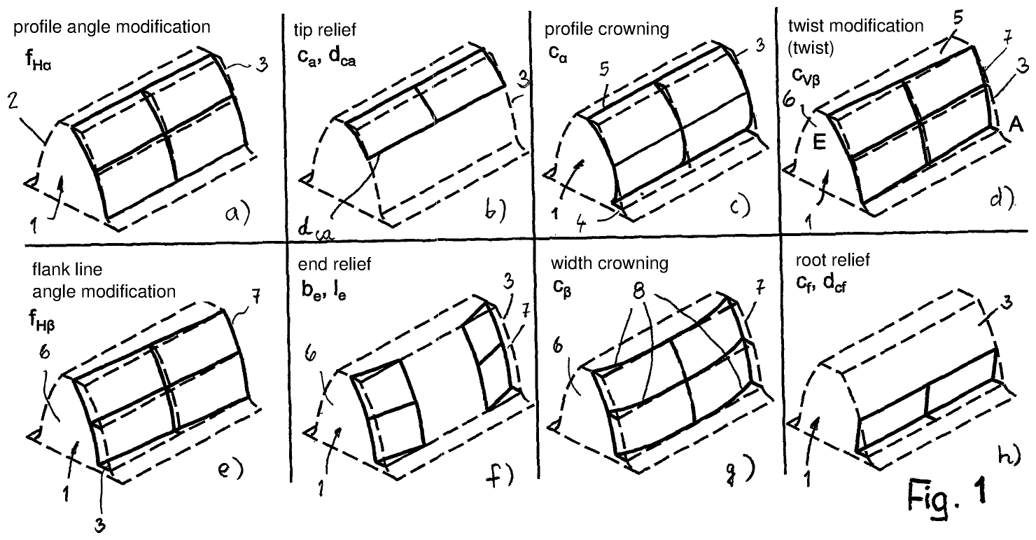

FIG. 1 different typical tooth flank modifications of gear wheels;

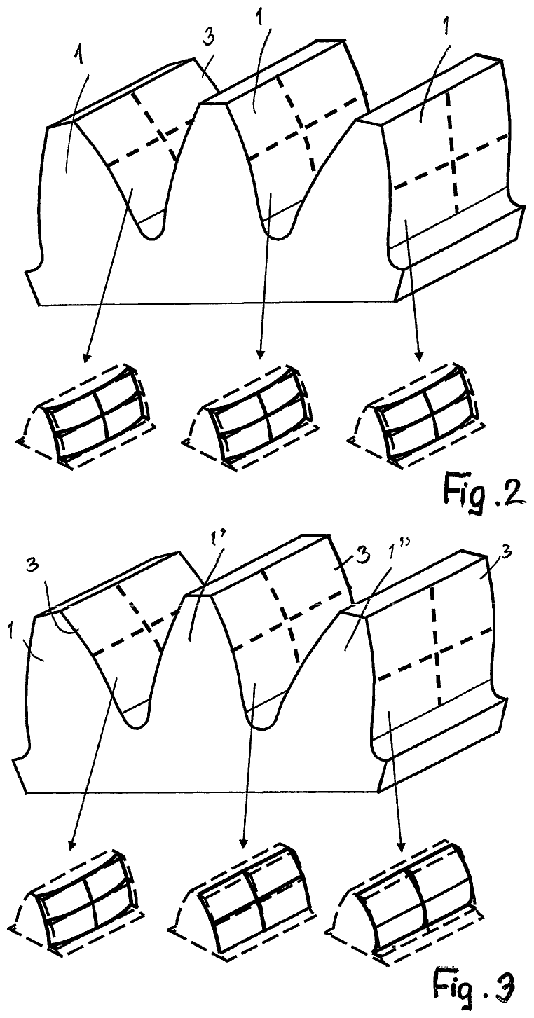

FIG. 2 the configuration of teeth of a gear wheel according to the prior art;

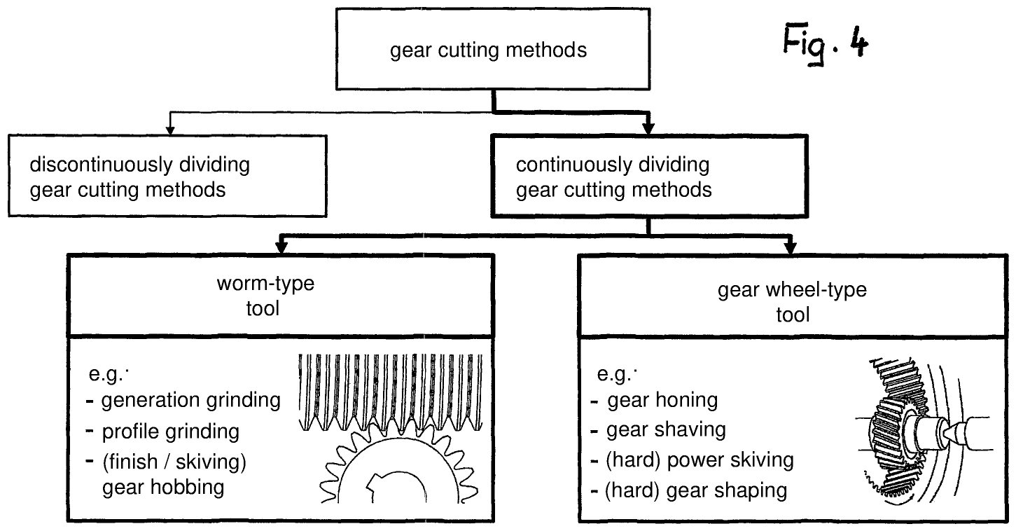

FIG. 3 in an illustration corresponding to FIG. 2, the teeth of a gear wheel produced according to the method according to the invention;

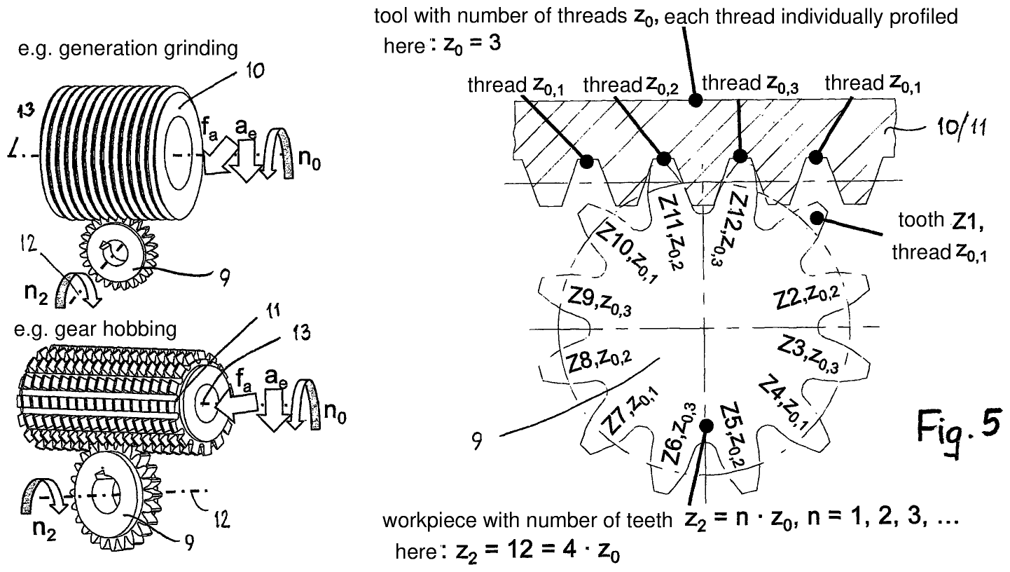

FIG. 4 a list of the conventional gear cutting methods;

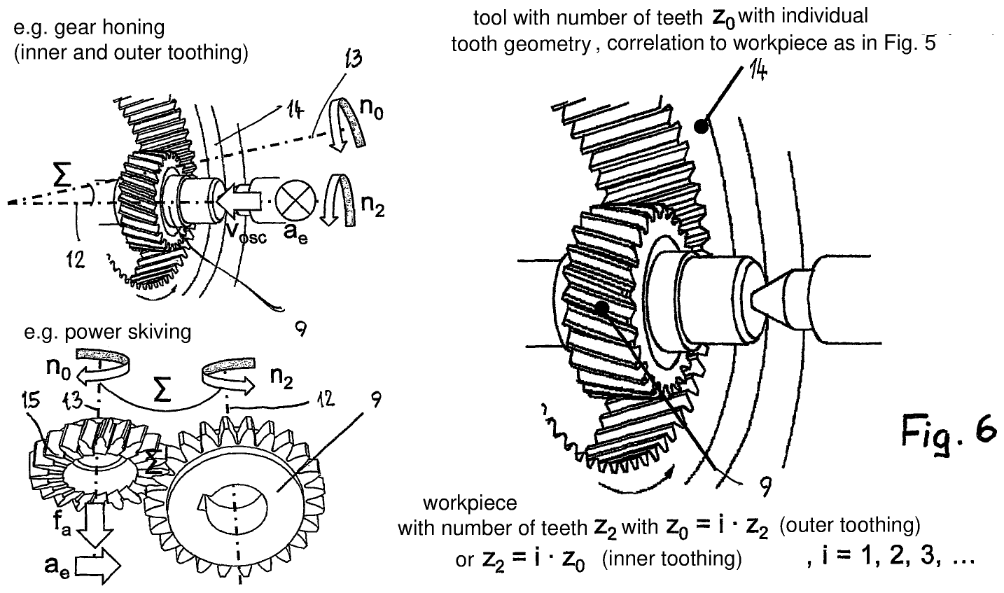

FIG. 5 performing the method according to the invention, illustrated with the aid of a worm-type tool with integer gear ratio;

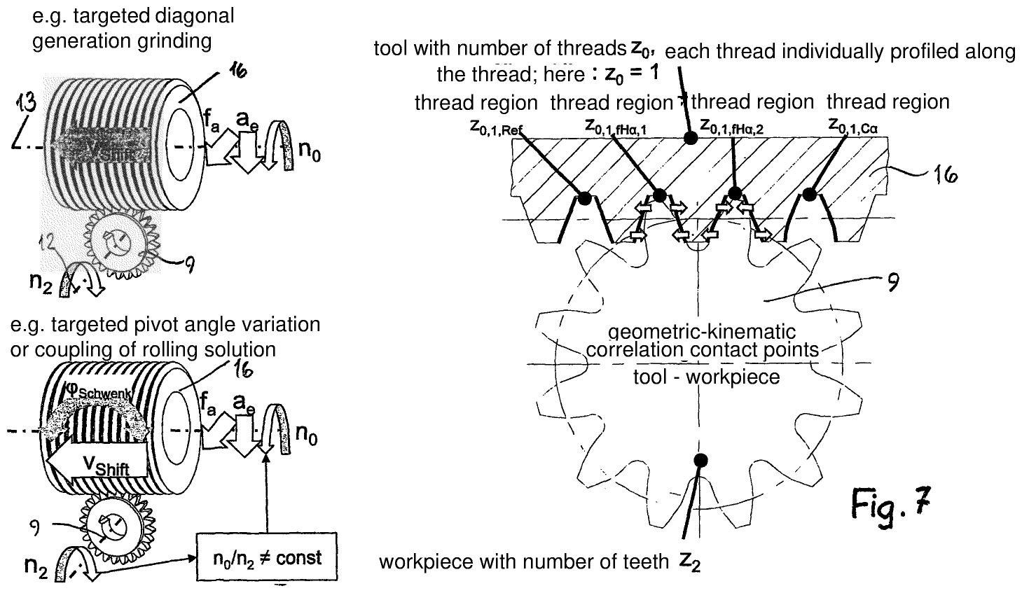

FIG. 6 in an illustration corresponding to FIG. 5, performing the method according to the invention by means of a gear wheel-type tool with integer gear ratio;

FIG. 7 the geometric kinematic realization of the method according to the invention for a worm-type tool with integer or non-integer gear ratio.

With the method disclosed in the following, individual teeth or threads of a tool are configured individually differently. For divider equality to the workpiece to be machined, these individual tooth geometries or thread geometries are applied onto the workpiece in a continuous method.

In case of no divider equality, in particular for worm-based tools, a variable tool geometry generation is realized not only per thread but also along the thread. Due to the coupling of the variable geometries thread by thread as well as along a thread with a corresponding feed kinematics, a flank-individual geometry is imprinted on the teeth of the workpiece.

In FIG. 1, typical tooth flank modifications are illustrated. The method can be used, of course, also for non-typical modifications.

FIG. 1a shows a profile angle modification f_{Hα} at a tooth. The profile angle modification is illustrated by the thick solid lines. The illustrated tooth 1 has the two tooth flanks 2, 3. With dashed lines, the unmachined tooth flanks are illustrated. In the embodiment, the tooth flank 3 has been machined by a corresponding tool such that this tooth flank comprises the profile angle modification that is indicated by the thick lines.

FIG. 1b shows as a tooth flank modification a tip relief cₐ of the tooth flank 3. The tip relief is again illustrated by thick solid lines. The tip relief cₐ begins at d_{ca} and extends to the addendum circle. The material removal for obtaining the tip relief thus increases, in an end face section, beginning at d_{ca} all the way to the addendum circle.

In FIG. 1c, a profile crowning c_{α} provided at the tooth flank 3 is illustrated. The profile crowning is provided across the height from the root 4 to the top land 5 as well as well as across the entire width of the tooth 1.

The tooth flank modification according to FIG. 1d is a twist c_{Vβ}. It is again illustrated by bold solid lines and provided at the tooth flank 3 of the tooth 1 in the embodiment. The twist c_{Vβ} extends across the height and the width of the tooth flank 3. The twist is designed such that the width of the top land 5 is smaller at the end face 6 of the tooth 1 than at the oppositely positioned end face 7. The root width of the tooth 1 in the region of the end face 6 is larger than in the region of the oppositely positioned end face 7. The configuration of the twist can also be carried out precisely in opposite direction in relation to the end faces.

A further typical tooth flank modification is illustrated in FIG. 1e. This is a flank line angle modification f_{Hβ}. It is provided at the tooth flank 3 of the tooth 1 and extends across the height of the tooth 1 as well as across its width. The solid lines show the flank line angle modification f_{Hβ}. Such a modification is produced by a linear relief of the material of the tooth 1 across its width. Accordingly, the end face 7 of the tooth 1 is wider across its height than the oppositely positioned end face 6.

The end relief bₑ, lₑ in FIG. 1f is a further typical tooth flank modification. The end relief is provided, for example, at the tooth flank 3 of the tooth 1. The end relief bₑ, lₑ results in that material is removed from the tooth 1 across a certain tooth width in the region of its two end faces 6, 7 across the tooth height. The two end reliefs at the tooth flank 3 are illustrated by solid lines.

In the production of the width crowning c_{β} (FIG. 1g), material is removed symmetrically in the direction toward the two end faces 6, 7 of the tooth 1. The width crowning c_{β} is therefore designed such that the flank lines extending across the width extend in a circular arc shape.

Finally, the root relief c_{f} is illustrated in FIG. 1h as a further typical tooth flank modification. It is provided across the width of the tooth flank 3 in the root region and extends only across a portion of the height of the tooth flank 3.

The tooth flank modifications illustrated with the aid of FIGS. 1a to 1h can be provided symmetrically or non-symmetrically and in different superpositions and sizes at both tooth flanks 2, 3.

FIG. 2 shows in an exemplary fashion three teeth 1 of a spur-toothed gear wheel. All teeth 1 of this gear wheel are provided in an exemplary fashion with a width crowning c_{β} at their tooth flank 3. All teeth 1 of this gear wheel are of the same configuration, i.e., they have each the same tooth flank modification.

FIG. 3 shows a portion of a gear wheel that is produced according to the method of the invention. With this method, it is possible to provide the tooth flanks 3 of the teeth 1 with different tooth flank modifications. For example, it is illustrated that the tooth 1 is provided with a width crowning c_{β} at its tooth flank 3, the tooth 1′ with a profile angle modification f_{Hα} at the tooth flank 3, and the tooth 1′ with a profile crowning c_{α} at the tooth flank 3.

The tooth flank modifications at the teeth of the gear wheel illustrated in FIG. 3 are to be understood only as examples. With the method, it is possible to vary in a targeted fashion at a gear wheel the teeth with respect to their tooth flank modifications.

With this method, it is possible to satisfy the increasing requirements in regard to the noise behavior of gear wheels in particular in the field of electromobility. Since in the field of electromobility no noise-emitting combustion engines are present anymore, the noise behavior of the gear wheels or of the gear mechanism plays an important role. The tonality of the tooth engagement in the gears comes to the fore in electromobility. The tonality is broken due to the tooth-by-tooth variable geometries. These variable geometries can be produced by means of a continuously working method so that a high productivity is achieved.

The method can be a machining method or a dressing method.

The teeth can be components of gear wheels but also of dressing tools and machining tools for producing such gear wheels.

With the aid of FIG. 4, it will be explained where the method is employed. The gear cutting methods can be divided into discontinuously as well as continuously dividing gear cutting methods. Relevant are the continuously dividing gear cutting methods. For this, worm-type tools can be employed, for example, for generation grinding, for profile grinding or for (finish/skiving) gear hobbing.

Alternatively, gear wheel-type tools can be employed. They are used, for example, in gear honing, gear shaving, (hard) power skiving or (hard) gear shaping.

With the aid of FIG. 5, machining of a workpiece 9 by a worm-type tool 10 or 11 will be explained. The gear ratio between the tool 10/11 and the workpiece 9 is an integer.

The workpiece 9 has the number of teeth z₂ which amounts to 12 in the embodiment.

The tool 10/11 has the number of threads z₀ wherein in the embodiment three threads are individually profiled. These differently profiled threads are identified in FIG. 5 by z_{0.1}, z_{0.2}, and z_{0.3}. The further threads of the tool 10/11 are embodied in a repetition in accordance with the threads z_{0.1} to z_{0.3}.

The number of teeth z₂ of the workpiece 9 results thus from the equation

z₂=n·z₀

herein with the meaning n=1, 2, 3, . . . .

Thus, the equation

z₂=12=4·z₀

applies in the illustrated embodiment.

The tool 10 is a grinding tool that is embodied of a worm-type configuration and advantageously is dressable.

The tool 10 is in engagement with the workpiece 9 during machining. The workpiece 9 in the form of a spur gear rotates at the rotational speed n₂ about its axis 13 which, in the usual manner, is positioned at an angle to the axis of rotation 12 of the workpiece 9.

The rotation of workpiece 9 and workpiece 10 is coupled kinematically in a known manner, wherein in addition the tool 10 is moved by a feed amount aₑ axially (axial feed fₐ) as well as advantageously tangentially in relation to the workpiece 9 in advancing direction. By means of the three individually profiled threads z_{0.1} to z_{0.3} of the tool 10, the corresponding tooth flanks of the workpiece 9 are profiled. Since the tool 10 comprises three differently profiled threads, corresponding differently modified tooth flanks can be produced at the teeth Z1 to Z12 by generation grinding.

As can be seen in FIG. 5, the tooth Z1 has, for example, the tooth flank modification which is determined by the thread z_{0.1} of the tool 10. The teeth Z2 and Z3 have the tooth flank modifications which are determined by the threads z_{0.2} and z_{0.3} of the tool 10. Subsequently, the tooth flank modifications are repeated at the teeth Z4 to Z6, Z7 to Z9, and Z10 to Z12.

When a gear hobbing tool that is of a worm-type configuration is used as a tool 11, in principle the same sequences as for use of the generation grinding cylinder 10 result. The workpiece 9 and the tool 11 are rotated about their respective axes 12, 13 at the rotational speeds n₂ and n₀. In a known manner, the two axes of rotation 12, 13 are positioned at an angle relative to each other. The rotation of workpiece 9 and tool 11 is coupled again kinematically so that the desired profile can be produced at the workpiece 9 by the tool 11.

The tool 11 in the form of the gear hobbing tool has, for example, three individually profiled threads z_{0.1} to z_{0.3}. Correspondingly, teeth comprising individually profiled tooth flanks, respectively, are produced at the workpiece 9 upon machining, as has been explained with the aid of the generation grinding method.

The two methods explained in an exemplary fashion by means of worm-type tool 10, 11 enable in a continuously working method the production of variable topographies tooth by tooth at the workpiece 9. In deviation from the embodiment, the tool 10, 11 can also be provided with only two individually profiled threads but also more than three individually profiled threads so that at the workpiece 9 a corresponding number of teeth with individually designed tooth flank modifications can be produced.

FIG. 6 shows two embodiments in which the tooth flank modifications at the workpiece 9 are produced by a gear wheel-type tool 14, 15.

The tools 14, 15 have the tooth number z₀ with an individual tooth geometry. The correlation of the respective tool 14, 15 to the workpiece 9 is realized in the same manner as in the embodiments according to FIG. 5. Between the tool 14, 15 and the workpiece 9, an integer gear ratio is provided.

The workpiece 14 is a cylindrical honing stone with inner toothing. In workpiece machining, the tool 14 is rotated about the axis 13 and the workpiece 9 about the axis 12 at the rotational speeds n₀ and n₂. The two axes of rotation 12, 13 are positioned at an axis crossing angle Σ relative to each other. The rotational speeds n₀ and n₂ are matched to each other in a known manner.

The workpiece 9 is displaced during machining at an oscillation speed v_{osc} in the direction of its axis 12 as well as perpendicularly thereto in accordance with the feed aₑ in the direction toward the tool 14. The gear honing is generally known and is therefore not explained here in more detail. The process applies in the same manner to workpieces with inner toothing as well as workpieces with outer toothing.

The workpiece 9 has the number of teeth z₂, wherein the correlation with the number of teeth z₀ of the tool 14 according to the equation z₀=i·z₂ applies, wherein i=1, 2, 3, . . . . This applies to a workpieces with outer toothing as illustrated in the embodiment.

When the workpiece has an inner toothing, then for the correlation between the number of teeth z₂ of the workpiece 9 and the number of teeth of the tool 15 the relation z₂=i·z₀ applies wherein i=1, 2, 3, . . . .

The tool 14 comprises teeth with different profiling so that the teeth of the workpiece 9 in the described manner can be provided with different tooth flank modifications, depending on the configuration of the teeth z₀ of the tool 14.

FIG. 6 shows as a further embodiment the power skiving by means of the tool 15. The tool 15 is rotated about its axis 13 and the workpiece about its axis 12 during the manufacture at the rotational speeds n₀ and n₂. The two axes 12, 13 are positioned at an axis crossing angle Σ relative to each other. The tool 15 is displaced during the machining in the direction of its axis 13 (axial advance fₐ) and at the same time radially in the direction toward the workpiece 9.

The rotations of workpiece 9 and tool 15 are coupled with each other in a known manner kinematically so that the tooth profile is produced in the desired degree. Due to the individual tooth geometries of the tool 15, teeth with individual flank modification can be produced at the workpiece 9 in a continuous method.

FIG. 7 shows further examples of how workpieces with individually configured tooth flank modifications can be produced in a continuous method.

In an exemplary fashion, the employed tool 16 is a worm-type grinding tool with which a diagonal generation grinding can be performed. In this method, an axial advance and tangential advance occur simultaneously with the rotation of the tool 16 about its axis 13.

The tool 16 has in an exemplary fashion the number of threads Z₀₌1. This thread along its length is provided with differently profiled thread regions, as is illustrated in an exemplary fashion. The thread region Z_{0.1}, _{Ref} forms a reference region with which a reference tooth flank modification is produced at the tooth of the workpiece.

The thread region Z_{0.1} is designed such that with it, in the disclosed manner, a profile angle modification f_{Hα} at the tooth flank of the workpiece tooth can be produced.

The thread region z_{0.1,fHα,2} is designed such that with it a further different profile angle modification at the tooth flank 3 of the workpiece tooth can be produced.

The thread region z_{0.1,cα} is formed such that with it at the tooth flank 13 of the workpiece 9 the profile crowning c_{α} can be produced.

The thread regions are positioned at such a distance one behind the other that each thread region machines the tooth flanks of different teeth of the workpiece.

In FIG. 7, it is indicated by the arrows how the workpiece removal at the tooth flanks of the workpiece is realized at the teeth of the workpiece 9 in relation to the thread regions producing the profile angle modification.

For diagonal generation grinding, the workpiece 9 and the tool 16 are rotated in a synchronized manner about their respective axes 12, 13 at rotational speeds n₀, n₂, wherein the two axes of rotation 12, 13, in a known manner, are arranged at a pivot angle relative to each other.

As can be taken furthermore from FIG. 7, the workpiece machining can also be varied in a targeted manner by a targeted pivot angle variation or a targeted coupling of rolling. In this way, the pivot angle φ of the tool 16 relative to the workpiece 9 can be changed.

For the coupling of rolling solution, it can be provided that the ratio of rotational speed n₀ of the tool 16 to the rotational speed n₂ of the workpiece 9 is not constant.

The pivot angle variation and the coupling of rolling variation are simply further examples as to how in a targeted fashion workpiece tooth flank modifications in a continuously rolling manufacturing method can be advantageously produced by affecting the method kinematics.

In the embodiment according to FIG. 7, the gear ratio between the worm-type tool 16 and the workpiece 9 can be integer or non-integer.

As shown with the aid of the examples of FIGS. 5 to 7, different flank modifications can be provided on toothings by a continuously rolling manufacturing method. When worm-type tools are employed (FIGS. 5 and 7), then dressable tools can be employed, wherein individual threads of the worm-type tools 10, 11, 16 can be individually dressed for producing variable tooth geometries in the individual threads. In the embodiment according to FIG. 5, three threads are provided at the worm-type tool 10, 11 which are each individually profiled (standard kinematics).

FIG. 7 shows in an exemplary fashion that along one thread of the worm-type tool 16 variable tool geometries along this thread can be dressed (diagonal kinematics).

When non-dressable tools are used for the worm-type tools 10, 11, 16, then the variable tool geometries along a thread are ground in different thread regions, as explained in an exemplary fashion with the aid of FIG. 7.

When realizing integer dividers between the number of teeth z₂ of the workpiece and the number of teeth z₀ of the tool, the same teeth of the workpiece 9 will always come into contact with the same thread of the tool 10, 11.

The result is that different thread geometries are imprinted onto the toothing of the workpiece 9 as variable geometries.

The use of the worm-type tool is in particular provided for finish gear hobbing, for generation grinding or for skiving gear hobbing.

When gear wheel-type tools are used as tools (FIG. 6), then the variable flank modifications at the toothings are produced also with continuously rolling manufacturing methods. In this context, dressable tools 14, 15 can be employed. For this dressing process, a dressing wheel with variable modifications can be used. In this method, an integer divider between the number of teeth z₂ of the workpiece 9 and the number of teeth z₀ of the tool is also realized. In this way, it is achieved that always the same teeth of the workpiece 9 come into contact with the same teeth of the tool 14.

In this way, the different dresser tooth geometries are imprinted onto the toothing as variable geometries by the tools 14, 15. In an exemplary fashion, the gear honing process is explained for this purpose.

With the aid of FIG. 6, also the power skiving has been explained. When the tool 15 is not dressable, then the individual teeth of the tool 15 are ground individually with the desired correction.

For this purpose, an integer divider between the number of teeth z₂ of the workpiece 9 and the number of teeth z₀ of the tool 15 is also realized so that always the same teeth of the workpiece 9 will come into contact with the same teeth of the tool 15.

Aside from skiving, for this purpose also shaving or in an exemplary fashion shaping are conceivable.

Due to the described divider equality of numbers of teeth of the workpiece and number of threads or number of teeth of the tool, in the described manner individual tool profile geometries are periodically imparted thread by thread or tooth by tooth onto the workpiece.

When during machining a targeted tool movement during the machining process is additionally performed, as explained in an exemplary fashion with the aid of FIGS. 5 to 7, individual geometries can be reinforced tooth by tooth at the workpiece 9.

In addition, or in place of the targeted supplemental tool movement, a variable geometry along a thread or periodically engaging tool teeth can also be used as well as the manufacturing kinematics can be expanded as described in order to reinforce an individual geometry on the workpiece tooth by tooth. In this way, elimination of the divider equality of number of teeth of the tool or number of threads of the tool and number of teeth of the workpiece is possible.

With the described method, machining methods and dressing methods can be performed. For this purpose, the described machining tools 10, 11, 14 to 16 as well as corresponding dressing tools are employed.

What is claimed is:

1.-14. (canceled)

15. A method for producing different tooth flank modifications on teeth of a workpiece, the method comprising:
providing a tool comprising individually different tool profile geometries;
producing the different tooth flank modifications on the teeth of the workpiece by the individually different tool profile geometries of the tool by employing a continuously rolling manufacturing method to move the workpiece and the tool in relation to each other and remove material from tooth flanks of the teeth of the workpiece.

16. The method according to claim 15, further comprising realizing an integer divider between a number of teeth of the workpiece and a number of teeth of the tool or a number of threads of the tool.

17. The method according to claim 15, further comprising selecting a worm-type tool as the tool comprising individually different tool profile geometries.

18. The method according to claim 17, further comprising providing the individually different tool profile geometries on the worm-type tool in the form of at least two threads that are differently profiled.

19. The method according to claim 17, further comprising providing the individually different tool profile geometries on the worm-type tool in the form of a thread that comprises differently profiled thread regions along a length of the thread.

20. The method according to claim 15, further comprising selecting a dressing tool configured to machine tools as the tool comprising individually different tool profile geometries.

21. The method according to claim 15, further comprising selecting a gear wheel-type tool as the tool comprising individually different tool profile geometries and providing the individually different tool profile geometries on the gear wheel-type tool in the form of teeth comprising different tooth geometries.

22. The method according to claim 15, further comprising selecting a dressable tool as the tool comprising individually different tool profile geometries and providing the individually different tool profile geometries on the dressable tool in the form of different tool profile geometries produced by a dressing tool.

23. A tool for performing the method according to claim 15, wherein the tool comprises individually different tool profile geometries.

24. The tool according to claim 23, wherein the tool is a worm-type tool and the individually different tool profile geometries are at least two threads that are differently profiled.

25. The tool according to claim 23, wherein the tool is a worm-type tool and the individually different tool profile geometries are differently profiled thread regions provided along a length of a thread.

26. The tool according to claim 23, wherein the tool is a gear wheel-type tool comprising teeth and the individually different tool profile geometries are individual tooth geometries of the teeth.

27. The tool according to claim 26, wherein the gearwheel-type tool comprises an outer toothing or an inner toothing.

28. The tool according to claim 23, wherein the tool is a dressing tool configured to dress dressable tools.
